(19) United States
(12) Patent Application Publication
(10) Pub. No.: US 2023/0392538 A1
(43) Pub. Date: Dec. 7, 2023

(54) COOLING FAN MODULE FOR A MOTOR VEHICLE

(71) Applicant: Brose Fahrzeugteile SE & Co. Kommanditgesellschaft, Würzburg, Würzburg (DE)

(72) Inventors: Christian Froh, Oldenburg (DE); Andre Evers, Oldenburg (DE)

(21) Appl. No.: 18/452,766

(22) Filed: Aug. 21, 2023

Related U.S. Application Data
(63) Continuation of application No. PCT/EP2022/054312, filed on Feb. 22, 2022.

(30) Foreign Application Priority Data
Feb. 24, 2021 (DE) 10 2021 201 750.9

(51) Int. Cl. F01P 5/06; F04D 29/38; F04D 29/32

(52) U.S. Cl. CPC F01P 5/06; F04D 29/384; F04D 29/326

(57) ABSTRACT

A radiator fan module for a motor vehicle has a fan shroud with a fan impeller aperture and a motor support disposed within the fan impeller aperture, for an electric motor, and has a support-side housing part and has a plurality of struts that are connected to the fan shroud. A fan impeller is disposed in the fan impeller aperture and is driven in rotation about an axis of rotation. The fan impeller has a hub-side housing part and a plurality of radially outwardly directed radiator fan blades disposed on the hub-side housing part. The support-side housing part and the hub-side housing part have different diameters, wherein the support-side housing part or the hub-side housing part that has a greater diameter overlaps the other of the support-side housing part or the hub-side housing part, with an air gap being formed.

### CROSS-REFERENCE TO RELATED APPLICATION

This application is a continuation, under 35 U.S.C. § 120, of copending International Patent Application PCT/EP2022/054312, filed Feb. 22, 2022, which designated the United States; this application also claims the priority, under 35 U.S.C. § 119, of German Patent Application DE 10 2021 201 750.9, filed Feb. 24, 2021; the prior applications are herewith incorporated by reference in their entirety.

### FIELD AND BACKGROUND OF THE INVENTION

The invention relates to a radiator fan module for a motor vehicle, having a fan shroud and having a motor support, connected to the fan shroud, for an electric motor, and having a fan impeller which is arranged in a fan impeller aperture of the fan shroud, which is driven in rotation, and which has blade arrangement composed of a number of radially outwardly directed radiator fan blades which are arranged on a hub of the fan impeller. Here, a motor vehicle is to be understood as also meaning a hybrid vehicle, which has an internal combustion engine and an electric motor that is fed by a rechargeable battery, or an electric vehicle.

In a motor vehicle, the drivetrain commonly includes an internal combustion engine that requires cooling. Since thermal radiation and convection are not sufficient to cool the internal combustion engine, such a cooling process is commonly assisted by a cooling air flow that results from the relative wind while the motor vehicle is in motion, and by a fan device. A cooling device in the form of a fluid-type cooling circuit is commonly interposed, with a heat exchanger (radiator) being exposed to the flow of relative wind and to the air flow from the fan device.

Such a fan device, also referred to as a fan system, commonly has a fan impeller, which is generally driven by an electric motor and which has a conveying element for air in the form of a blade wheel or propeller. Such a fan impeller is arranged rotatably within a fan impeller aperture in the form of an opening extending all the way through a fan shroud. The efficiency of the fan device is particularly high if the gap between the fan impeller and the edge of the opening in the fan shroud is as small as possible and if adverse, efficiency-reducing flow influences are avoided, or reduced as far as possible, in the region of the hub of the fan impeller and a motor support for the electric motor.

The fan device is typically arranged behind the radiator core of the radiator (heat exchanger) as viewed in a direction of travel of the motor vehicle. By means of the fan impeller of the fan device (of the fan), the air is drawn in a main flow direction through the radiator core and is directed onto the internal combustion engine. The fan impeller of the fan device is arranged in a circular aperture of the shroud body, which substantially completely covers the radiator core, of the fan shroud that guides the air through the radiator core.

To achieve a high efficiency of the fan, the shroud body is substantially air-tight aside from the circular fan impeller aperture. The pressure difference between the region in front of the radiator core and the region behind the shroud body—in each case as viewed in the direction of travel of the vehicle and from upstream in the main flow direction of the air flow—is thus relatively large. Thus, when the vehicle is at a standstill, the fan draws a relatively large quantity of air through the radiator core of the radiator. Once the motor vehicle is moving at a relatively high speed, the relative wind backs up in front of the shroud body and the radiator core. Since only a certain proportion of the relative wind thus passes through the radiator core, closable ram pressure flap openings can be formed in the shroud body in order to improve cooling, as is known for example from published, non-prosecuted German patent application DE 10 2013 006 499 A1.

A limitation or reduction of the efficiency of the fan or fan system can also result from an unfavorable, for example intensely swirling gap flow in the region of the hub of the fan impeller and of the motor support. In particular if the motor support is situated with its struts upstream the fan impeller, that is to say in front of the fan impeller in a direction of travel or counter to the main flow direction, the swirling flow can mix with the main flow in a manner which adversely affects efficiency, or can negatively interact with the fan impeller.

### SUMMARY OF THE INVENTION

It is the object of the invention to specify a particularly suitable radiator fan module for a motor vehicle, in particular also for a hybrid vehicle that is driven by internal combustion engine and electric motor. In particular, it is sought to as far as possible avoid the disadvantages that are associated with a swirling gap flow in the region of the hub of the fan impeller and of the motor support.

The object is achieved according to the invention by means of the features of the independent claim. The subclaims relate to advantageous embodiments and refinements.

The radiator fan module for a motor vehicle has a fan shroud with a fan impeller aperture formed therein, within which fan impeller aperture there is arranged a motor support which has a support-side housing part for an electric motor and has a number of struts which are mechanically connected to the fan shroud and which are for example arranged in the manner of spokes. The radiator fan module furthermore has a fan impeller which is arranged in the fan impeller aperture and which is driven in rotation about an axis of rotation by the electric motor and which has a number of radially outwardly directed radiator fan blades, which are arranged on a (hub-side) housing part that forms a hub.

The housing parts have an axial, preferably at least approximately cylindrical, housing wall, and a housing base. The housing parts are for example of shell-like form, and will hereafter also be referred to as support-side and hub-side housing shells respectively. The support-side housing part has a housing wall extending in an axial direction, which overlaps or is overlapped by the housing wall, extending in an opposite direction, of the hub-side housing part. The housing parts or shells have different diameters, wherein the housing shell or the housing part with the greater or relatively large diameter overlaps, in particular in an axial direction, the other housing shell or the other housing part with the smaller or relatively small diameter, with an air gap being formed which extends in particular in a radial direction.

A housing shell is thus to be understood to mean a housing part that has a substantially cylindrical housing wall and has a housing base. The support-side housing part (the support-side housing shell) preferably has an annular base, that is to say a base that is not completely closed. Improved cooling of the electric motor that is used is thus achieved. Here, the struts of the motor support are preferably arranged in front of the radiator fan blades in relation to the main flow direction, that is to say in a direction of travel. The in particular annular housing base also expediently faces toward the main flow, such that the cooling of the electric motor is further improved.

The radiator fan blades are expediently sickle-shaped, and in this case backwardly sickle-shaped. This means that, as viewed in a direction of rotation of the fan impeller, the leading edge of the radiator fan blades is convexly bulged, and the trailing edge is concavely indented. The leading edge and/or the trailing edge of the radiator fan blades is expediently of undulating form. The leading edge of the radiator fan blades is in particular the edge that is situated at the front in a direction of rotation, while the trailing edge of the radiator fan blades is the edge that is situated at the back in a direction of rotation.

In a first variant, the diameter of the support-side housing part, that is to say the diameter of the housing shell of the motor support, is greater than the diameter of the hub-side housing part, that is to say of the housing shell of the fan impeller. The support-side housing part, which accommodates the electric motor, in particular the stator-side elements or motor parts thereof, is expediently of annular design or designed as an annular shell. It is expediently the case in this variant that the housing shell of the motor support overlaps the housing shell of the fan impeller. In this variant, a gap volume flow in the main flow direction arises in the region of the overlapping housing shells.

It is also possible in a second variant for the diameter of the housing shell of the fan impeller, that is to say the hub-side housing part, to be greater than the diameter of the housing shell of the motor support. In this variant, in which the housing shell of the fan impeller overlaps that of the motor support, a gap volume flow counter to the main flow direction, or in a direction opposite to the main flow direction, arises in the region of the overlapping housing shells.

In one advantageous embodiment, that housing shell which overlaps the other housing shell has an incident-flow surface which is inclined relative to the main flow direction. That housing shell which overlaps the other housing shell expediently has an incident-flow surface which runs at an angle of between 0° and 20°, preferably 5° to 15°, with respect to the axial direction and/or the axis of rotation of the fan impeller.

Between the support-side housing part and the hub-side housing part, an axial gap is expediently formed, which is covered by an overlapping edge of that housing part which has the greater diameter, with a radial gap being formed.

In the context of the invention, a fan impeller is in particular a rotationally symmetrical component which has a hub, in particular a hub cup, as a housing shell or housing part, which connects the fan impeller to a motor shaft or to a rotor of the electric motor such that the torque generated by the electric motor is transmitted to the fan impeller. The fan impeller furthermore has a blade arrangement with multiple radiator fan blades which are provided and configured to generate an air volume flow when the fan impeller is set in rotational motion. The blades (blade airfoils) are in this case preferably inclined relative to the axis of rotation. The radiator fan blades of the fan impeller are expediently connected at the ends of the blades, in particular at the blade tips thereof, to an outer ring.

In the context of the present invention, the hub or the hub cup is in particular a central part of the fan impeller which is arranged in the middle of the fan impeller and which provides a connection to a drive, in particular to the electric motor, and which at least partially covers said drive and, similarly to a classic cup or a housing shell, is assembled from a planar base surface (as housing base) and an adjoining cylinder surface (as housing wall). In particular, the blades (radiator fan blades) are arranged, in particular integrally formed, on said cylindrical outer wall.

In the context of the present invention, a motor support is in particular a static component with a central housing or housing part, in particular in the form of an expediently annular housing shell, which at least partially receives the static part of the drive, in particular the stator and optionally a set of motor electronics and a motor or stator housing of the electric motor. The motor support or motor holder has struts which are in particular oriented radially and which are preferably integrally formed on the support-side housing shell and connected to the static fan shroud. The fan impeller aperture thereof is suitably delimited by a shroud ring.

The advantages achieved with the invention consist in particular in that, owing to different diameters of the support-side and fan-impeller-side housing parts or housing shells and the (radial) overlap thereof (in an axial direction), adverse flow influences are avoided, and high system efficiency is achieved.

Other features which are considered as characteristic for the invention are set forth in the appended claims.

Although the invention is illustrated and described herein as embodied in a cooling fan module for a motor vehicle, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a diagrammatic, perspective view of a radiator fan module having a fan shroud, having a motor support that is fixed to the shroud, and having a fan impeller with a blade arrangement, in a view directed toward a hub-side housing part of the fan impeller;

FIG. 2 is a perspective view of a detail of a hub-side housing part with radiator fan blades integrally formed thereon;

FIG. 3 is a perspective view of a detail of a support-side housing part with an annular housing base and with integrally formed struts for retention on the fan shroud;

FIG. 4 is a perspective and sectional view in a region of the housing parts that overlap so as to form a gap;

FIG. 5 shows the sectional illustration as per FIG. 4 in a plan view, with the hub-side housing part being overlapped by the support-side housing part in a first variant,

FIG. 6 is a sectional view, as per FIG. 5, of a second variant with the support-side housing part being overlapped by the hub-side housing part; and

FIGS. 7A and 7B schematically show the first and the second variant, with the direction of a gap volume flow between the overlapping housing parts being indicated.

### DETAILED DESCRIPTION OF THE INVENTION

Mutually corresponding parts are denoted by the same reference designations in all of the figures.

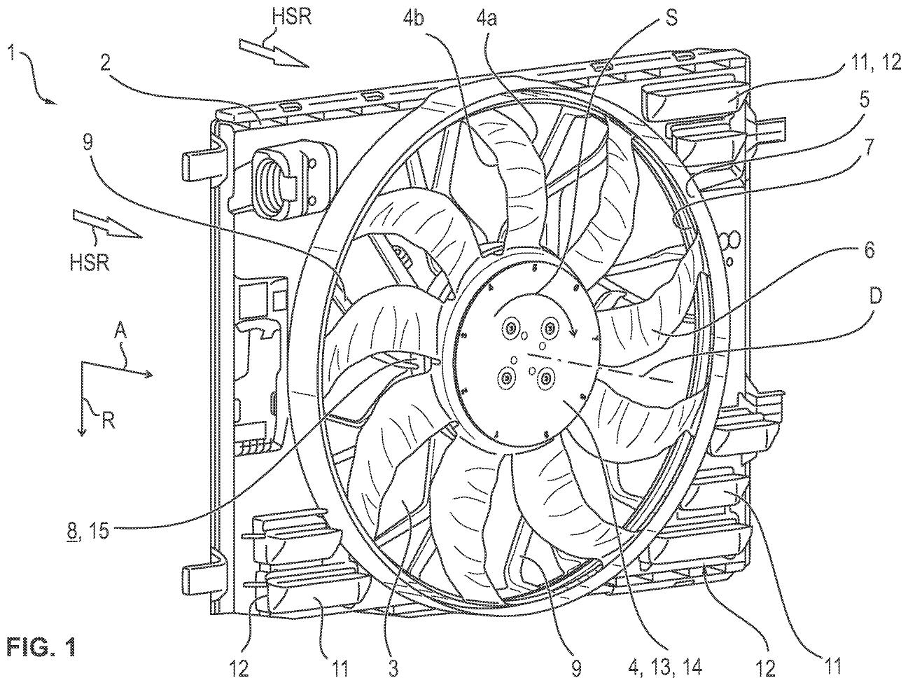

Referring now to the figures of the drawings in detail and first, particularly to FIG. 1 thereof, there is shown a modular radiator, or a radiator fan module 1, having a fan shroud 2 in which a circular or round radiator fan aperture 3 for a radiator fan 4 is formed, wherein the fan impeller aperture 3 is delimited by a shroud ring 5. The fan impeller 4 has a number of radiator fan blades 6 that are connected to one another by means of an outer ring 7 that is integrally formed on the blade tips of the radiator fan blades 6. A motor support (motor holder) 8 is arranged within the fan impeller aperture 3 and is connected via struts 9 to the fan shroud 2.

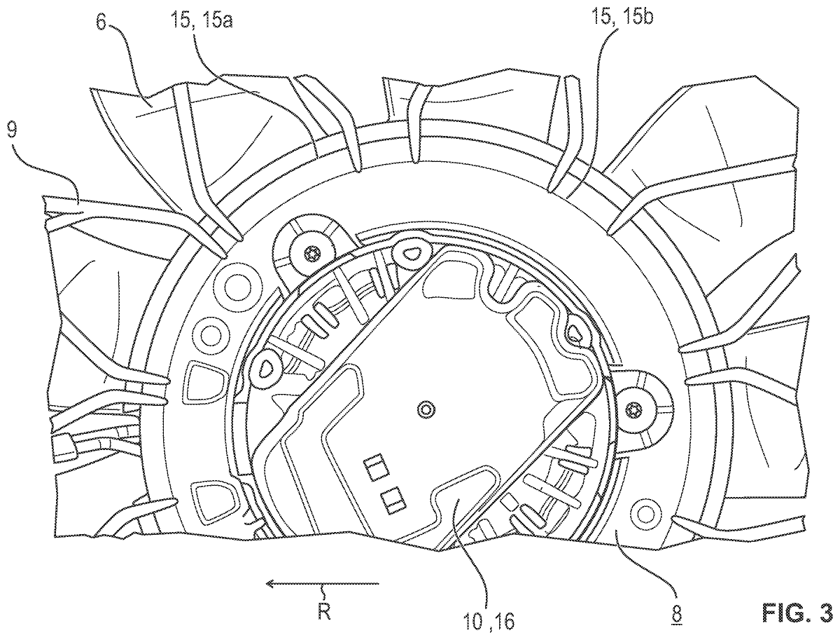

The motor support 8 holds an electric motor 10 that is not visible here (see FIGS. 3 to 5). The fan impeller 4 is arranged in the fan impeller aperture 3 and is driven in rotation about an axis of rotation D by the electric motor 10. The support-side struts 9 are arranged in front of the fan impeller 4 as viewed in a flow direction HSR (main flow direction). In other words, the struts 9 of the motor support 8 are arranged in front of the radiator fan blades in relation to the main flow direction HSR, that is to say in a direction of travel of a motor vehicle that has the radiator fan module 1.

The fan shroud 2 has ram pressure openings 12 which are closable by means of ram pressure flaps 11 and which, in the exemplary embodiment, are arranged in three corner regions of the fan shroud 2, outside the fan impeller aperture 3 thereof.

The radiator fan blades 6 are sickle-shaped, and in this case are backwardly sickle-shaped in relation to the direction of rotation S indicated by the arrow, such that the leading edge 4a of the radiator fan blades 4, which is situated at the front in the direction of rotation S of the fan impeller 4, is convexly bulged, and the trailing edge 4b, which is situated at the back, is concavely indented. The leading edge 4a and preferably also the trailing edge 4b of the radiator fan blades 4 are of undulating form.

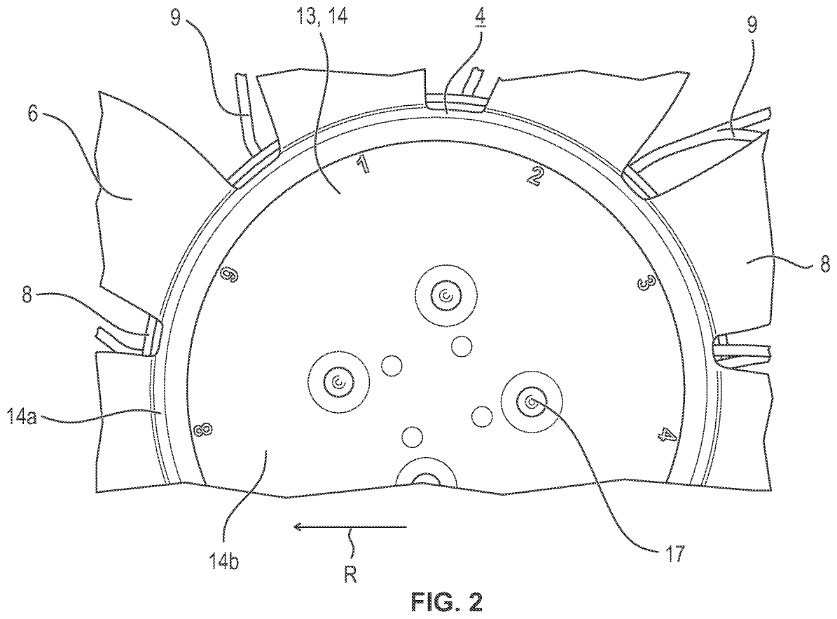

FIGS. 2 and 3 show the radiator fan module 1 in a detail in the region of the hub 13 of the fan impeller 4 which, there, has a hub-side housing part 14, hereinafter also referred to as housing shell. The hub-side housing part has a cylindrical housing wall 14a and a housing base 14b. The radiator fan blades 6 are integrally formed, by way of their blade roots, on the cylindrical housing wall 14a of the fan-impeller-side or hub-side housing part 14.

A support-side housing part 15, which can be seen relatively clearly in FIG. 3 and which is situated opposite the hub-side housing part 14 and which will hereinafter also be referred to as housing shell of the motor support 8, likewise has a cylindrical housing wall 15a and has a housing base 15b of annular form. The struts 9 that connect the motor support 8 to the fan shroud 2 in the region of the fan impeller aperture 3 thereof are integrally formed on the outside of the cylindrical housing wall 15a of the support-side housing part 15. The electric motor 10 is held in the housing part 15 of the motor support 8.

It is possible to see a stator-side housing element of the motor housing 16, for example an electronics compartment cover for covering a set of motor electronics of the electric motor 10. The latter is designed here as an internal-rotor motor, the rotor of which is, by means of fastening elements 17 (FIG. 2), for example by means of rivets, connected to the hub 13 of the fan impeller 4, and specifically attached to the housing base 14b of the hub-side housing part 14. The preferably electronically commutated electric motor 10 may also be designed as an external-rotor motor.

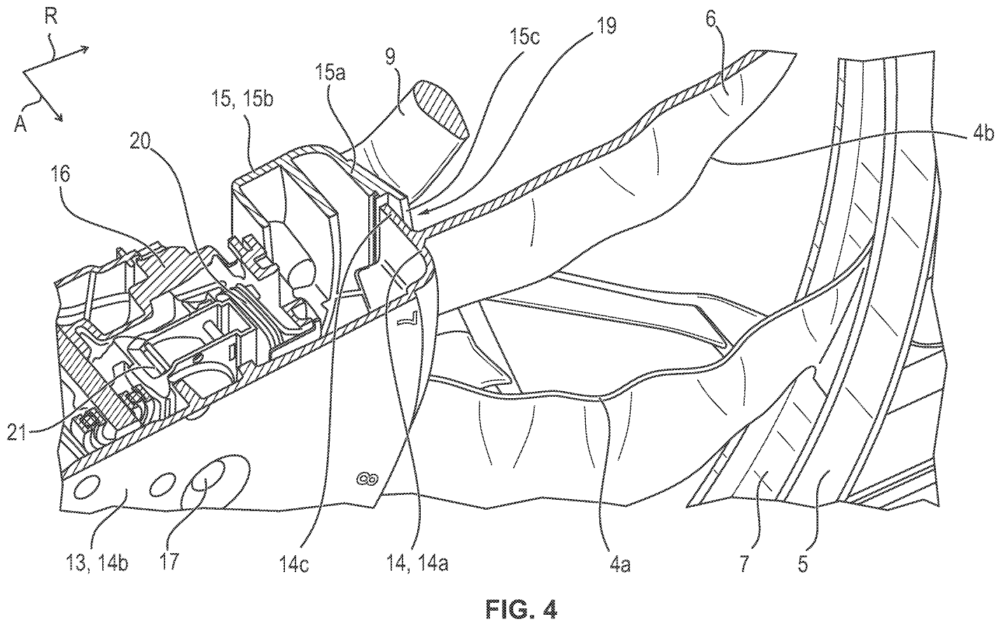

FIGS. 4 to 6 show, in a perspective view or in a plan view, a sectional illustration in the region of the overlapping housing parts 14 and 15 of the radiator fan module 1. As can be seen, the housing parts 14 and 15 have housing edges 14c, 15c, which overlap in an axial direction A, of the respective housing walls 14a and 15a. In the region of this overlap 18, a gap 19 is formed between the housing edges 14c, 15c, or between the housing walls 14a, 15a, of the housing parts 14 and 15.

It is also possible in FIGS. 4 to 6 to see the electric motor 10 enclosed by the housing parts 14, 15, with its stator 20, which bears a rotating-field winding, and its rotor 21, which is connected to the hub-side housing part 14. The housing parts 14, 15 are for example of shell-like form, and will hereafter also be referred to as support-side and hub-side housing shells respectively.

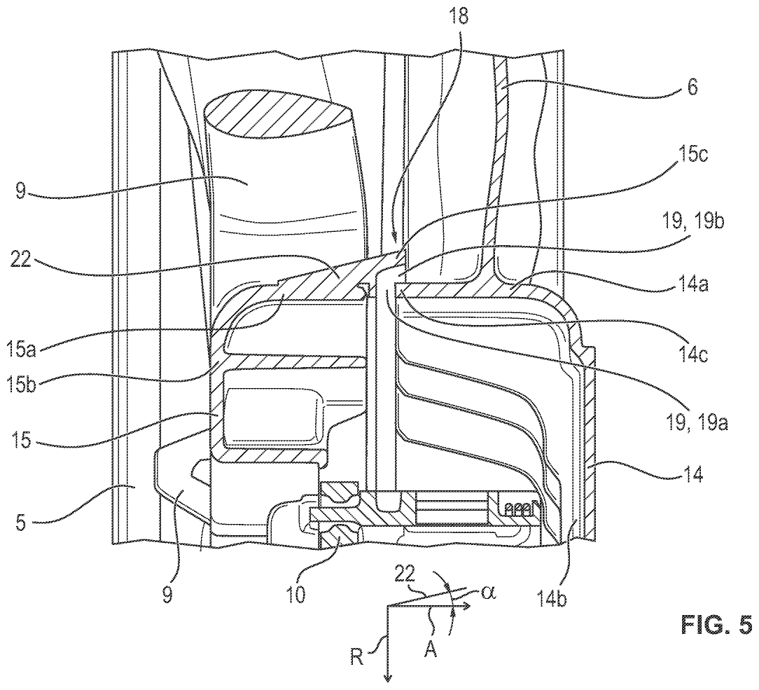

In the embodiment of FIG. 5, the gap 19, proceeding from an (axial) gap portion 19a between the housing parts 14, 15, extends initially in a radial direction R and then runs with a (radial) gap portion 19b in an axial direction A. That housing wall 15a of the support-side housing part 15 which extends in the axial direction A partially or regionally overlaps the housing wall 14a, extending in an opposite direction, of the hub-side housing part 14. In other words, the preferably circular, peripherally closed housing edge 15c of the support-side housing part 15 engages over the preferably likewise circular, peripherally closed housing edge 14c of the hub-side housing part 14.

The support-side housing shell 15, which overlaps or axially regionally covers the hub-side housing shell 14, has an incident-flow surface 22 which is inclined relative to the main flow direction HSR. The incident-flow surface 22 runs at an angle (of incidence) a of preferably 5° to 15° relative to the axial direction A or the axis of rotation D of the fan impeller 4, as is merely indicated below FIG. 5 by a line representation for the sake of clarity.

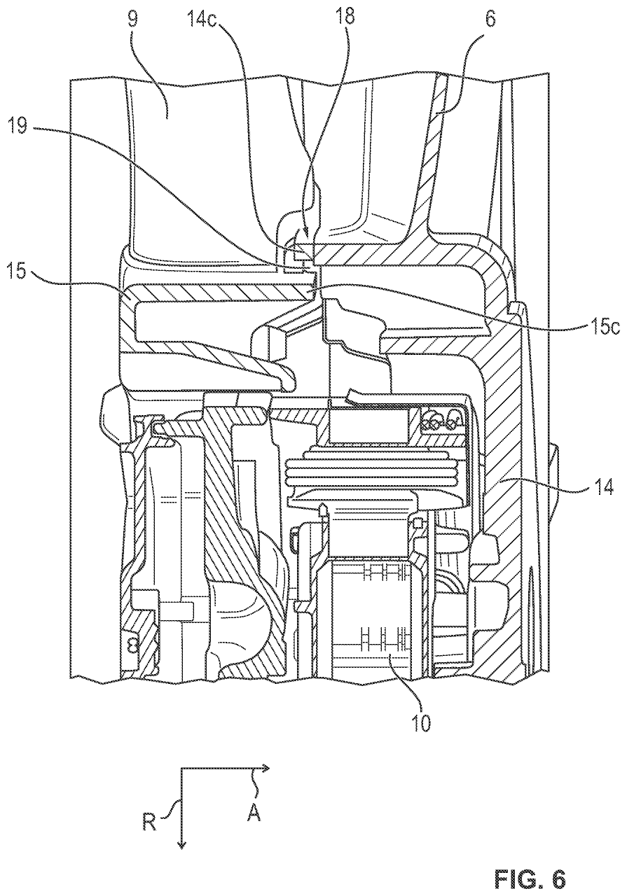

In the embodiment as per FIG. 6, the gap 19 between the housing parts 14, 15 extends in the axial direction A. That housing edge 14c of the hub-side housing part 14 which extends in the axial direction A overlaps the housing edge 15c, extending in an opposite direction, of the support-side housing part 15.

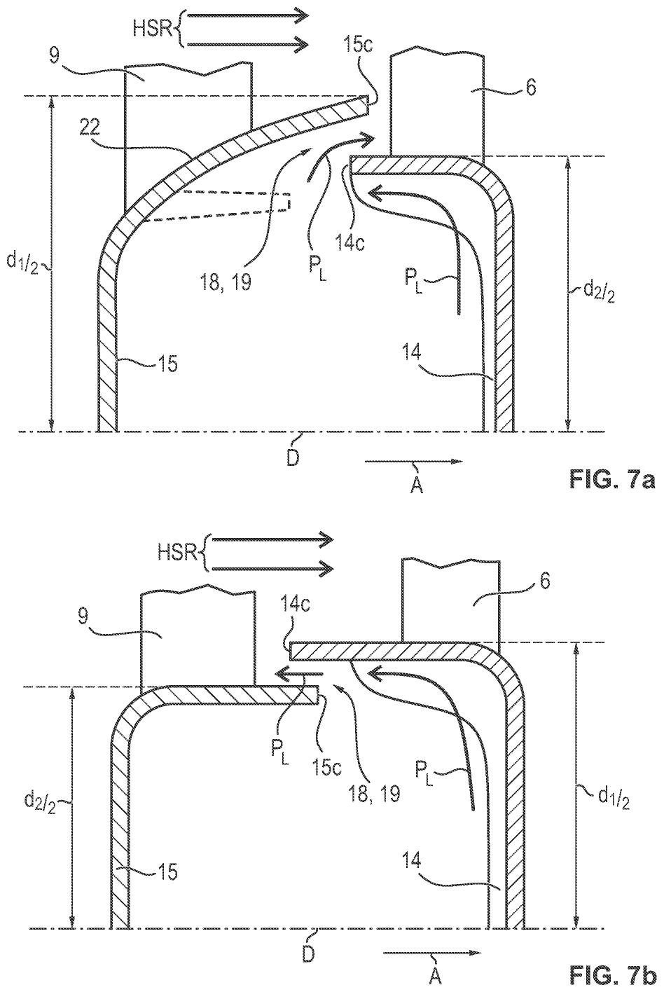

FIGS. 7a and 7b schematically show, in a sectional illustration, the embodiments of FIGS. 5 and 6 as a first and a second variant of the overlapping housing parts 14, 15. The illustrations show a region of the housing parts 14, 15 above the axis of rotation D of the fan impeller 4. The housing parts or housing shells 14 and 15 have different diameters d1, d2 or different radii r1=d1/2 and r2=d2/2.

In the variant as per FIG. 7A, the (support-side) housing part 15 of the motor support 8 with the greater diameter d1=r1/2 overlaps the (hub-side) housing part 14 of the fan impeller 14 with the smaller diameter d2=r2/2 so as to form, in the axial direction A, the air gap 19 that extends in a radial direction R. In this variant, the gap volume flow in the main flow direction HSR, as indicated by the flow arrows PL, arises in the region of the overlap 18 of the housing shells 14, 15.

In the variant as per FIG. 7B, the (hub-side) housing part 14 of the fan impeller 14, which in this case has the greater diameter d1=r1/2, overlaps the (support-side) housing part 15 of the motor support 8, which in this case has the smaller diameter d2=r2/2. In the region of the overlap 18 of the housing shells 14, 15, the air gap 19 extends in an axial direction A counter to the main flow direction HSR. In this variant, a gap volume flow in an opposite direction in relation to the main flow direction HSR, as indicated by the flow arrows PL, thus arises in the region of the overlapping housing shells 14, 15.

In summary, the invention relates to a radiator fan module 1 having a fan shroud 2, having a motor support 8 which has a (support-side) housing part and having a rotationally driven fan impeller 4 with a number of radiator fan blades 6 which are arranged on a hub-side housing part 14, wherein the housing parts 14, 15 have different diameters d1, d2, and wherein the housing part 14, with the greater diameter d1 overlaps the other housing part 15, 14, with an air gap 19 being formed. Owing to the different diameters d1, d2 of the support-side and fan-impeller-side housing parts 14, 15 and the (radial) overlap 18 thereof (in the axial direction A), adverse flow influences are avoided, and high system efficiency is thus achieved.

The radiator fan module 1 is particularly suitable for motor vehicles having an internal combustion engine, and in particular also for a hybrid vehicle or for an electric vehicle for the purposes of cooling the (drive) battery.

The claimed invention is not restricted to the exemplary embodiments described above. Rather, a person skilled in the art may also derive other variants of the invention from these within the scope of the disclosed claims, without departing from the subject matter of the claimed invention. In particular, all individual features described in conjunction with the various exemplary embodiments may also be combined in other ways within the scope of the disclosed claims, without departing from the subject matter of the claimed invention.

The following is a summary list of reference numerals and the corresponding structure used in the above description of the invention.

### LIST OF REFERENCE DESIGNATIONS

1 Radiator fan module
2 Fan shroud
3 Fan impeller aperture
4 Fan impeller
4a Leading edge
4b Trailing edge
5 Shroud ring
6 Radiator fan blades
7 Outer ring
8 Motor support/holder
9 Strut
10 Electric motor
11 Ram pressure flap
12 Ram pressure opening
13 Hub
14 Hub-side housing part
14a Housing wall
14b Housing base
14c Housing edge
15 Support-side housing part
15a Housing wall
15b Housing base
15c Housing edge
16 Motor housing
17 Fastening element
18 Overlap
19 Air gap/Gap
19a Axial gap portion
19b Radial gap portion
20 Stator
21 Rotor
22 Incident-flow surface
α Angle (of incidence)
A Axial direction
D Axis of rotation
PL Flow arrow
R Radial direction
S Direction of rotation
HSR Main flow direction

1. A radiator fan module for a motor vehicle, the radiator fan module comprising:
a fan shroud having a fan impeller aperture formed therein;
a motor support, disposed within said fan impeller aperture, for an electric motor, having a support-side housing part and having a plurality of struts that are connected to said fan shroud;
a fan impeller disposed in said fan impeller aperture, and is driven in rotation about an axis of rotation, said fan impeller having a hub-side housing part and a plurality of radially outwardly directed radiator fan blades disposed on said hub-side housing part; and
said support-side housing part and said hub-side housing part have different diameters, wherein said support-side housing part or said hub-side housing part that has a greater diameter overlaps the other of said support-side housing part or said hub-side housing part, with an air gap being formed.

2. The radiator fan module according to claim 1, wherein said struts of said motor support are disposed in front of said radially outwardly directed radiator fan blades in relation to a main flow direction.

3. The radiator fan module according to claim 1, wherein:
a diameter of said support-side housing part is greater than a diameter of said hub-side housing part; or
the diameter of said hub-side housing part is greater than the diameter of said support-side housing part.

4. The radiator fan module according to claim 1, wherein:
said support-side housing part has a housing wall or housing edge extending in an axial direction, which overlaps a housing wall or housing edge, extending in an opposite direction, of said hub-side housing part; or
said hub-side housing part has said housing wall or said housing edge, extending in the axial direction, which overlaps said housing wall or said housing edge, extending in an opposite direction, of said support-side housing part.

5. The radiator fan module according to claim 1, wherein:
said housing part which overlaps said other housing part has an incident-flow surface which is inclined relative to a main flow direction; or
said housing part which overlaps said other housing part has an incident-flow surface which runs at an angle of between 0° and 20° with respect to an axial direction and/or the axis of rotation.

6. The radiator fan module according to claim 1, wherein:
said hub-side housing part and said support-side housing part have a gap formed therebetween; and/or
said hub-side housing part and said support-side housing part have a first, radial, gap portion formed therebetween and is covered by an overlapping edge of said housing part which has the greater diameter, with a second, axial, gap portion being formed.

7. The radiator fan module according to claim 1, wherein:
said radially outwardly directed radiator fan blades are sickle-shaped; and/or
said radially outwardly directed radiator fan blades each have a leading edge and/or a trailing edge being of undulating form.

8. The radiator fan module according to claim 1, wherein:
said hub-side housing part is of shell-shaped form; and/or
said support-side housing part is of annular-shell-shaped form.

9. The radiator fan module according to claim 1, wherein said struts (9) of said motor support are integrally formed on an outside of said support-side housing part.

10. The radiator fan module according to claim 1, wherein:
said fan impeller aperture is delimited by a shroud ring; and/or
said fan impeller has an outer ring that connects said radially outwardly directed radiator fan blades.

11. The radiator fan module according to claim 5, wherein said angle (α) runs between 0° and 20°.

12. The radiator fan module according to claim 7, wherein said radiator fan blades are backwardly sickle-shaped.
